(19) United States
(12) Patent Application Publication
(10) Pub. No.: US 2022/0088634 A1
(43) Pub. Date: Mar. 24, 2022

(54) METHOD OF PRODUCING A BATTERY ELECTRODE

(71) Applicant: VARTA Microbattery GmbH, Ellwangen Jagst (DE)

(72) Inventors: Andreas Gaugler, Ellwangen (DE); Thomas Scheler, Ellwangen-Rindelbach (DE); Dieter Antis, Ellwangen (DE)

(21) Appl. No.: 17/543,790

(22) Filed: Dec. 7, 2021

Related U.S. Application Data
(62) Division of application No. 16/515,710, filed on Jul. 18, 2019.

(30) Foreign Application Priority Data
Aug. 6, 2018 (EP) 18187441.3

(51) Int. Cl. B05C 5/02; B05D 1/26; F16K 5/12; F16K 5/08; F16K 5/04; B05C 11/10

(52) U.S. Cl. CPC B05C 5/0258; B05D 1/26; B05C 5/0233; B05C 11/1026; F16K 5/08; F16K 5/0471; B05C 5/0254; F16K 5/12

(57) ABSTRACT

A method of producing a battery electrode includes dispensing a pasty coating material by a coating installation onto a surface of a moving substrate, wherein the coating installation includes a switchable slotted valve, a feed device that feeds the pasty coating material to the slotted valve, and a slotted nozzle that adjoins the slotted valve and dispenses the pasty coating material onto the surface to be coated therewith; the switchable slotted valve includes a valve bore incorporated into a valve basic body, oriented in a valve direction of extent and having an inner circumferential surface, a feed duct arranged in a region of the inner circumferential surface of the valve bore and opens into the valve bore, a nozzle duct arranged in the region of the inner circumferential surface, a valve sleeve arranged in the valve bore, and a control rod arranged in the valve bore.

### TECHNICAL FIELD

This disclosure relates to a switchable valve for a coating installation that controls the dispensing of a pasty coating material, as well as a coating installation having a switchable slotted valve, a method of coating surfaces and a method of producing a battery electrode.

### BACKGROUND

US 2004/0261696 A1 or U.S. Pat. No. 6,174,372 A, for example, discloses switchable slotted valves for coating installations. Such valves have in a valve basic body a valve bore oriented in a valve direction of extent and into which a feed duct opens and out of which leads a nozzle duct that connects to a slotted nozzle of the coating installation. In the valve bore of a known slotted valve there is arranged a valve control rod mounted in the valve bore to be rotatable about an axis of rotation extending in the valve direction of extent and traversed by a valve duct having a duct inlet extending axially along an outer side of the valve control rod and an exactly the same opposite duct outlet connected to one another via the valve duct.

In such known slotted valves, the valve control rod can be rotated by a motor or pneumatically between a passage position and a closed position. In the passage position, the valve control rod is arranged such that the coating material fed through the feed duct can pass through the duct inlet into the valve duct and from there through the duct outlet into the nozzle duct, from where it is fed as intended to the slotted nozzle of the coating installation. In the closed position, in contrast, the nozzle duct is isolated from the feed duct by the valve control rod, with the result that the dispensing of coating material is interrupted.

Bearing surfaces that, for the purpose of bearing of the valve control rod, lie against the inner circumferential surface of the valve bore, can be provided on the valve control rod in the region of two outer circumferential partial surfaces between the slot-shaped duct inlet and the slot-shaped duct outlet. This is known from EP 2 900 388 B1 and EP 2 900 389 B1, for example. Since the valve control rod is rotatable, a bearing gap of generally at most 100 μm remains between such bearing surfaces and the inner circumferential surface of the valve bore in the bearing region.

The known slotted valves serve for the targeted control of the dispensing of the coating material through a slotted nozzle. For this purpose, they are arranged upstream of the slotted nozzle and, by rotation of the valve control rod, allow the feed of the coating material to the slotted nozzle to be temporarily interrupted. This is used in particular to dispense coating material through the slotted nozzle and to interrupt the dispensing in an alternating manner.

Coating installations having such slotted valves are used in particular to produce battery electrodes. In this context, they dispense a pasty coating material containing electrochemically active particles such as graphite particles, for example, in the form of a thin layer. In particular, such a layer can be applied as an active material layer directly to a strip-shaped current collector. However, a coating is also understood as meaning the temporary application to a carrier substrate such as a roller or a flat carrier substrate, for example, from which the layer formed from the coating material is, as intended, removed again in subsequent production steps, for example, for the then-intended application to the current collector.

In addition to the dispensing of a coating material having electrochemically acting particles for the production of a battery electrode, such coating installations can also be used to produce an electrocatalytic layer of a fuel cell. In that instance, particularly coating materials can be processed that contain, as electrochemically active particles, catalyst particles (noble metals, Raney nickel, tungsten carbide, molybdenum sulfides, tungsten sulfides or similar suitable materials) that can catalyse the cold combustion of fuels such as hydrogen or methanol.

In such coating installations, the slotted nozzle customarily has arranged upstream thereof a paste reservoir from which the coating material is fed to the slotted valve and to the downstream slotted nozzle. It is possible that not only configurations in which the paste reservoir itself is pressurized to press the coating material in the direction of the slotted valve, but also those configurations in which a separate motor-driven delivery means such as a pump, for example, is connected between paste reservoir and slotted valve.

The known slotted valves from, in particular EP 2 900 388 B1 and EP 2 900 389 B1, have a significant disadvantage, namely that they are markedly maintenance-intensive. It quite regularly arises that coating material guided through the slotted valves penetrates into the aforementioned bearing gap. On the one hand, this is not undesired since materials used in battery electrode production frequently contain graphite and other constituent parts that can act as lubricants. On the other hand, however, such materials regularly also contain particles having a relatively high hardness, for example, oxide particles. Upon rotation of the valve control rod, they rub both against the inner circumferential surface of the valve bore and against the outer side of the valve control rod. This results in wear, thereby making necessary a regular regrinding of the inner circumferential surface of the valve bore and an accompanying exchange of the valve control rod for a control rod of larger diameter. Already after the first regrinding, the serviced slotted valve is fundamentally a one-off requiring a control rod specifically adapted in its diameter. This makes the battery electrode production considerably more expensive.

It could therefore be helpful to provide a slotted valve that allows more favorable battery electrode production.

### SUMMARY

We provide a switchable slotted valve for a coating installation that controls dispensing of a pasty coating material, including a valve bore incorporated into a valve basic body, oriented in a valve direction of extent and having an inner circumferential surface, a feed duct arranged in a region of the inner circumferential surface of the valve bore and opens into the valve bore, a nozzle duct arranged in the region of the inner circumferential surface of the valve bore and leads out from the valve bore, a valve sleeve arranged in the valve bore and has an inner circumferential surface that delimits a cavity oriented in the valve direction of extent, and an outer circumferential surface, wherein the valve sleeve includes a slot-shaped sleeve inlet opening into the cavity and a slot-shaped sleeve outlet leading out from the cavity, a valve control rod arranged in the valve bore, and is traversed by a valve duct having a slot-shaped duct inlet and a slot-shaped duct outlet, wherein the valve sleeve is non-rotatably mounted in the valve bore such that the feed duct connects to the cavity via the sleeve inlet, and the cavity connects to the nozzle duct via the sleeve outlet, the valve control rod is mounted in the cavity of the valve sleeve to be rotatable about an axis of rotation extending in the valve direction of extent, the valve control rod is rotatable in the valve sleeve between a passage position and a closed position, wherein, in the passage position, the feed duct and the nozzle duct communicatively connect via the valve duct and the sleeve inlet and the sleeve outlet, and wherein, in a closed position, the nozzle duct is isolated from the feed duct by the valve control rod.

We also provide a coating installation that coating surfaces in a continuous method with a pasty coating material, including a switchable slotted valve, a feed device that feeds the coating material to the slotted valve, a slotted nozzle that adjoins the slotted valve and dispenses the coating material onto the surface to be coated therewith, and the slotted valve is formed including a valve bore incorporated into a valve basic body, oriented in a valve direction of extent and having an inner circumferential surface, a feed duct arranged in a region of the inner circumferential surface of the valve bore and opens into the valve bore, a nozzle duct arranged in the region of the inner circumferential surface of the valve bore and leads out from the valve bore, a valve sleeve arranged in the valve bore and has an inner circumferential surface that delimits a cavity oriented in the valve direction of extent, and an outer circumferential surface, wherein the valve sleeve includes a slot-shaped sleeve inlet opening into the cavity and a slot-shaped sleeve outlet leading out from the cavity, a valve control rod arranged in the valve bore, and is traversed by a valve duct having a slot-shaped duct inlet and a slot-shaped duct outlet, wherein the valve sleeve is non-rotatably mounted in the valve bore such that the feed duct connects to the cavity via the sleeve inlet, and the cavity connects to the nozzle duct via the sleeve outlet, the valve control rod is mounted in the cavity of the valve sleeve to be rotatable about an axis of rotation extending in the valve direction of extent, the valve control rod is rotatable in the valve sleeve between a passage position and a closed position, wherein, in the passage position, the feed duct and the nozzle duct communicatively connect via the valve duct and the sleeve inlet and the sleeve outlet, and wherein, in a closed position, the nozzle duct is isolated from the feed duct by the valve control rod.

We further provide a method of dispensing a coating material on a surface, including dispensing the coating material by the coating installation including a switchable slotted valve, a feed device that feeds the coating material to the slotted valve, a slotted nozzle that adjoins the slotted valve and dispenses the coating material onto the surface to be coated therewith, and the slotted valve is formed for a coating installation that controls dispensing of a pasty coating material, including a valve bore incorporated into a valve basic body, oriented in a valve direction of extent and having an inner circumferential surface, a feed duct arranged in a region of the inner circumferential surface of the valve bore and opens into the valve bore, a nozzle duct arranged in the region of the inner circumferential surface of the valve bore and leads out from the valve bore, a valve sleeve arranged in the valve bore and has an inner circumferential surface that delimits a cavity oriented in the valve direction of extent, and an outer circumferential surface, wherein the valve sleeve includes a slot-shaped sleeve inlet opening into the cavity and a slot-shaped sleeve outlet leading out from the cavity, a valve control rod arranged in the valve bore, and is traversed by a valve duct having a slot-shaped duct inlet and a slot-shaped duct outlet, wherein the valve sleeve is non-rotatably mounted in the valve bore such that the feed duct connects to the cavity via the sleeve inlet, and the cavity connects to the nozzle duct via the sleeve outlet, the valve control rod is mounted in the cavity of the valve sleeve to be rotatable about an axis of rotation extending in the valve direction of extent, the valve control rod is rotatable in the valve sleeve between a passage position and a closed position, wherein, in the passage position, the feed duct and the nozzle duct communicatively connect via the valve duct and the sleeve inlet and the sleeve outlet, and wherein, in a closed position, the nozzle duct is isolated from the feed duct by the valve control rod.

We also further provide a method of producing a battery electrode, including dispensing a pasty coating material by a coating installation onto a surface of a moving substrate, wherein the coating installation includes a switchable slotted valve, a feed device that feeds the pasty coating material to the slotted valve, and a slotted nozzle that adjoins the slotted valve and dispenses the pasty coating material onto the surface to be coated therewith; the switchable slotted valve includes a valve bore incorporated into a valve basic body, oriented in a valve direction of extent and having an inner circumferential surface, a feed duct arranged in a region of the inner circumferential surface of the valve bore and opens into the valve bore, a nozzle duct arranged in the region of the inner circumferential surface of the valve bore and leads out from the valve bore, a valve sleeve arranged in the valve bore and having an inner circumferential surface that delimits a cavity oriented in the valve direction of extent, and an outer circumferential surface, wherein the valve sleeve includes a slot-shaped sleeve inlet opening into the cavity and a slot-shaped sleeve outlet leading out from the cavity, and a valve control rod arranged in the valve bore, and is traversed b y a valve duct having a slot-shaped duct inlet and a slot-shaped duct outlet; and the valve sleeve is non-rotatably mounted in the valve bore such that the feed duct connects to the cavity via the sleeve inlet, and the cavity connects to the nozzle duct via the sleeve outlet, the valve control rod is mounted in the cavity of the valve sleeve and adapted to be rotatable about an axis of rotation extending in the valve direction of extent, and the valve control rod is rotatable in the valve sleeve between a passage position and a closed position, wherein, in the passage position, the feed duct and the nozzle duct communicatively connect via the valve duct and the sleeve inlet and the sleeve outlet, and wherein, in a closed position, the nozzle duct is isolated from the feed duct by the valve control rod.

### BRIEF DESCRIPTION OF THE DRAWINGS

FIG. 1 illustrates one example of a valve sleeve of a slotted valve.

FIG. 2 illustrates one example of a valve control rod of a slotted valve.

FIG. 3 illustrates the valve sleeve illustrated in FIG. 1 with inserted valve control rod according to FIG. 2.

FIG. 4 illustrates one example of a coating installation having a slotted valve.

FIG. 5 illustrates a cross section, in the form of a detail, through the slotted valve illustrated in FIG. 4.

### DETAILED DESCRIPTION

Our slotted valve is a switchable slotted valve for a coating installation that controls the dispensing of a pasty coating material. It is distinguished by the directly following features a. to i.:

a. It comprises a valve bore incorporated into a valve basis body and is oriented in a valve direction of extent and has an inner circumferential surface.

b. It comprises a feed duct arranged in the region of the inner circumferential surface of the valve bore and opens into the valve bore.

c. It comprises a nozzle duct arranged in the region of the inner circumferential surface of the valve bore and leads out from the valve bore.

d. It comprises a valve sleeve arranged in the valve bore and has an inner circumferential surface, which delimits a cavity oriented in the valve direction of extent, and an outer circumferential surface.

e. The valve sleeve comprises a slot-shaped sleeve inlet opening into the cavity and a slot-shaped sleeve outlet leading out from the cavity.

f. It comprises a valve control rod arranged in the valve bore, and is traversed by a valve duct having a slot-shaped duct inlet and a slot-shaped duct outlet.

g. The valve sleeve is non-rotatably mounted in the valve bore, with the result that the feed duct connects to the cavity via the sleeve inlet, and the cavity connects to the nozzle duct via the sleeve outlet.

h. The valve control rod is mounted in the cavity of the valve sleeve to be rotatable about an axis of rotation extending in the valve direction of extent.

i. The valve control rod is rotatable in the valve sleeve between a passage position and a closed position, wherein, in the passage position, the feed duct and the nozzle duct communicatively connect via the valve duct and the sleeve inlet and the sleeve outlet, and wherein, in the closed position, the nozzle duct is isolated from the feed duct by the valve control rod.

The slotted valve thus differs from the prior art in that the valve control rod is not mounted directly in the valve bore. Instead, the valve sleeve is provided for this purpose. The valve sleeve is non-rotatably mounted in the valve bore such that, upon operation of the slotted valve, wear of the inner circumferential surface of the valve bore is eliminated. The wear is limited instead to the inner circumferential surface of the valve sleeve. Since, however, this is easily exchangeable and can be produced in a comparatively favorable manner, a considerable advantage results from its use. The complicated and expensive regrinding of the valve bore is completely dispensed with.

A slotted valve means a valve in which the feed duct, the nozzle duct, the sleeve inlet opening into the cavity, the sleeve outlet leading out of the cavity and the valve duct traversed by the valve control rod have a considerably greater extent in a dimension transversely to the conveying direction than in the dimension orthogonal thereto and likewise extends transversely to the conveying direction. According to the definition of a slotted valve, the extent of the respective ducts in the valve direction of extent is greater at least by a factor of 4 than the extent transversely to the valve direction of extent. With respect to the valve control rod, there is provision that the latter has a length in the valve direction of extent, along which it is traversed by the valve duct, which is at least four times as large as the mean radius of the valve control rod. The length of the valve control rod, along which it is traversed by the valve duct, is preferably and usually greater by a larger factor than the maximum dimeter of the valve control rod, preferably at least by a factor of 10.

The valve basic body is preferably a metal basic body in which the valve bore is incorporated by machining, for example. The valve bore itself is a rotationally symmetrical and preferably cylindrical clearance whose length is at least four times as large as the mean radius.

The valve bore is preferably cylindrical. However, this does not by all means necessarily have to be the case. It can also have a rectangular cross section, for example. What is important is that the valve sleeve can be mounted therein such that the feed duct connects to the cavity via the sleeve inlet, and the cavity connects to the nozzle duct via the sleeve outlet. For this purpose, the valve sleeve can have a rectangular outer cross section, for example.

The feed duct opens into the valve bore, and the nozzle duct runs out of the valve bore, wherein both ducts connect to the valve bore by slot-like openings extending primarily in the valve direction of extent. The absolute length of the valve bore and the substantially identical width of the feed duct and of the nozzle duct in the region of the circumferential surface of the valve bore and of the valve duct are at least 30 mm, preferably at least 100 mm. Depending on the intended application, the length of the bore or the width of the respective ducts can be up to 2000 mm and more. The mean diameter of the valve bore, in particular the diameter of the cylindrical valve bore, is preferably <30 mm. The width of the entry of the feed duct and of the exit into the nozzle duct is preferably at least four times the height of the entry or the exit.

At least the cavity of the valve sleeve is preferably cylindrical. Further preferably, the valve sleeve is cylindrical overall. The dimensions of the cavity are adapted to the diameter and the length of the valve control rod. The dimensions of the slot-shaped sleeve inlet opening into the cavity and of the slot-shaped sleeve outlet leading out of the cavity preferably correspond to the dimensions of the slot-like openings via which the feed duct and the nozzle duct are connected to the valve bore. If the valve sleeve is cylindrical, its wall diameter is preferably 1 mm to 10 mm.

To produce a valve control rod of a switchable slotted valve, it is appropriate to manufacture the valve control rod in one piece to the effect that all outer surfaces and the walls defining the valve duct connect to one another in one piece. In particular, it is appropriate to incorporate the slot-shaped valve duct starting from a cylindrical blank.

To produce a valve sleeve of a switchable slotted valve, it is appropriate to manufacture the valve sleeve in one piece to the effect that all outer surfaces and the inner circumferential surface defining the cavity connect to one another in one piece. In particular, it is appropriate at first to incorporate the cylindrical cavity starting from a cylindrical blank and then to incorporate the slot-shaped sleeve inlet opening into the cavity and the slot-shaped sleeve outlet leading out of the cavity into the walls of the resulting hollow cylinder.

Particularly preferably, the slotted valve has following features a. and b.:

a. The valve control rod is cylindrical and comprises an outer circumferential surface breached only by the slot-shaped duct inlet and the slot-shaped duct outlet.

b. The outer circumferential surface of the valve control rod lies directly against the inner circumferential surface of the valve sleeve.

It is known from EP 2 900 388 B1 to provide outer circumferential surfaces of the valve control rod with depression regions. This is not absolutely necessary. Rather, particularly preferably, the exact opposite is provided, namely the use of a valve control rod without such depression regions. Preferably, the valve control rod is thus strictly cylindrical and free of depression regions in which the valve control rod does not lie against the inner circumferential surface of the valve sleeve. Preferably, the outer circumferential surface of the valve control rod acts as a whole as a bearing surface which is in direct contact with the inner circumferential surface of the valve sleeve.

By contrast, particularly preferably, the valve control rod is formed as described in EP 2 900 388 B1. In this example, the slotted valve is distinguished by features a. to c.:

a. The valve control rod comprises an outer circumferential surface breached by the slot-shaped duct inlet and the slot-shaped duct outlet.

b. Bearing surfaces, that for the purpose of bearing of the valve control rod, lie against the inner circumferential surface of the valve sleeve, are provided on the valve control rod in the region of two partial surfaces of the outer circumferential surface between the slot-shaped duct inlet and the slot-shaped duct outlet.

c. Depression regions are provided on the outer circumferential partial surfaces, in the region of which depression regions the respective outer circumferential partial surface does not lie against the inner circumferential surface of the valve sleeve.

The partial surfaces of the outer circumferential surface are the two partial surfaces extending in the circumferential direction and counter to the circumferential direction from the duct inlet to the duct outlet of the valve duct. The width of the outer circumferential partial surfaces corresponds to the maximum width of the valve duct in the valve direction of extent.

Whereas the outer circumferential surface of the valve control rod is adapted to the valve sleeve such that it has a spacing of less than 100 μm with respect to the rotationally symmetrical circumferential inner surface thereof, the spacing in the depression regions is greater. A depression region means a region in which the spacing is at least 0.5 mm.

The outer circumferential surface of the valve control rod of a slotted valve is thus preferably divided into bearing surfaces and depression regions. The bearing surfaces and the depression regions can be distributed here in many different ways.

Particularly preferably, the slotted valve is distinguished by the directly following features a. to c.:

a. The valve control rod comprises an outer circumferential surface which is breached only by the slot-shaped duct inlet and the slot-shaped duct outlet.

b. The outer circumferential surface of the valve control rod lies in certain regions directly against the inner circumferential surface of the valve sleeve.

c. The inner circumferential surface of the valve sleeve comprises at least one depressed subregion in which the outer circumferential surface of the valve control rod does not lie against the inner circumferential surface of the valve sleeve.

Whereas, in the slotted valves in EP 2 900 388 B1, the outer circumferential surfaces of the valve control rod are provided with depression regions, it is the inner circumferential surface of the valve sleeve that is provided therewith here.

We further provide a coating installation for coating surfaces in a continuous method with a pasty coating material. This is distinguished by features a. to d.:

a. It comprises a switchable slotted valve.

b. It comprises a feed device that feeds the coating material to the slotted valve.

c. It comprises a slotted nozzle adjoining the slotted valve that dispenses the coating material onto the surface to be coated therewith.

d. The slotted valve is formed as described above.

In such a coating installation, the feed device preferably comprises a paste store in which a coating material suitable for battery production is held available, that is to say in particular a coating material having electrochemically active particles that can produce a battery electrode.

We further provide a method of coating a surface in which the described coating installation is used. It is preferably a method of dispensing a coating material forming a battery electrode.

Further features, details and advantages will emerge from the description below, the appended claims, the abstract and the following description of preferred examples and on the basis of the drawings.

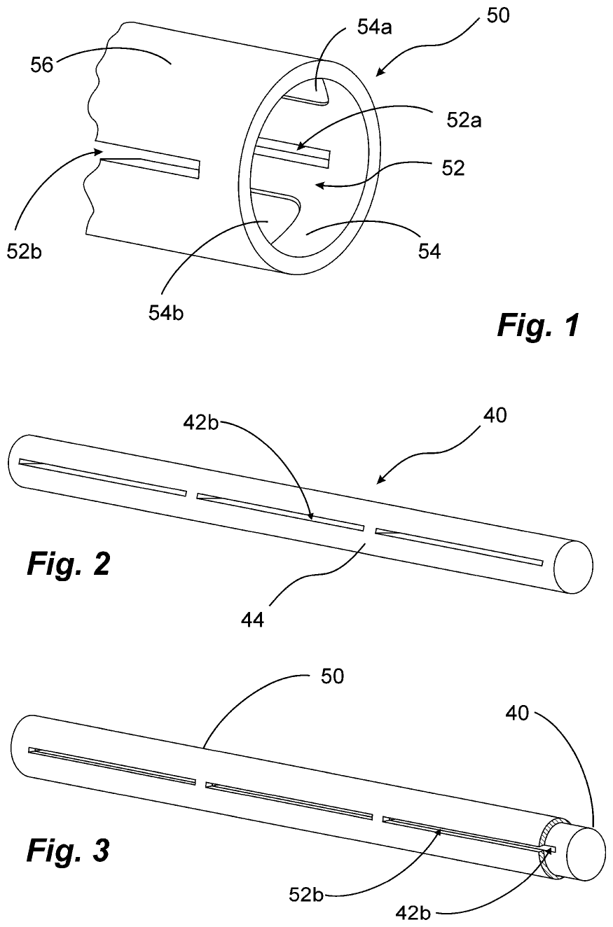

FIG. 1 shows an end piece of one example of a valve sleeve 50 of a slotted valve. The valve sleeve 50 is hollow-cylindrical and comprises an inner circumferential surface 54 that delimits an axially oriented cavity 52, and an outer circumferential surface 56. The wall of the valve sleeve 50 is breached only by the slot-shaped sleeve inlet 52a opening into the cavity and the slot-shaped sleeve outlet 52b leading out of the cavity.

The inner circumferential surface 54 of the valve sleeve 50 comprises the depressed subregions 54a and 54b. If for instance the cylindrical valve control rod 40 illustrated in FIG. 2 is inserted into the cavity 52, the outer circumferential surface 44 of the valve control rod 40 does not lie against the inner circumferential surface 54 of the valve sleeve 50 in these subregions. However, in many examples of the slotted valve, the depressed subregions are dispensed with. Incorporation of the depressions is very complicated.

FIG. 2 shows one example of a valve control rod 40 of a slotted valve. The valve control rod 40 is traversed by the valve duct 42, which has a slot-shaped duct inlet 42a (on the rear side, not visible here, of the valve control rod 40) and a slot-shaped duct outlet 42b.

FIG. 3 shows the valve sleeve 50 illustrated in FIG. 1 and the valve control rod 40 illustrated in FIG. 2, wherein the latter is inserted into the cavity 52 and rotated to the passage position. In this position, the sleeve inlet 52a and the sleeve outlet 52b communicatively connect to one another via the valve duct 42.

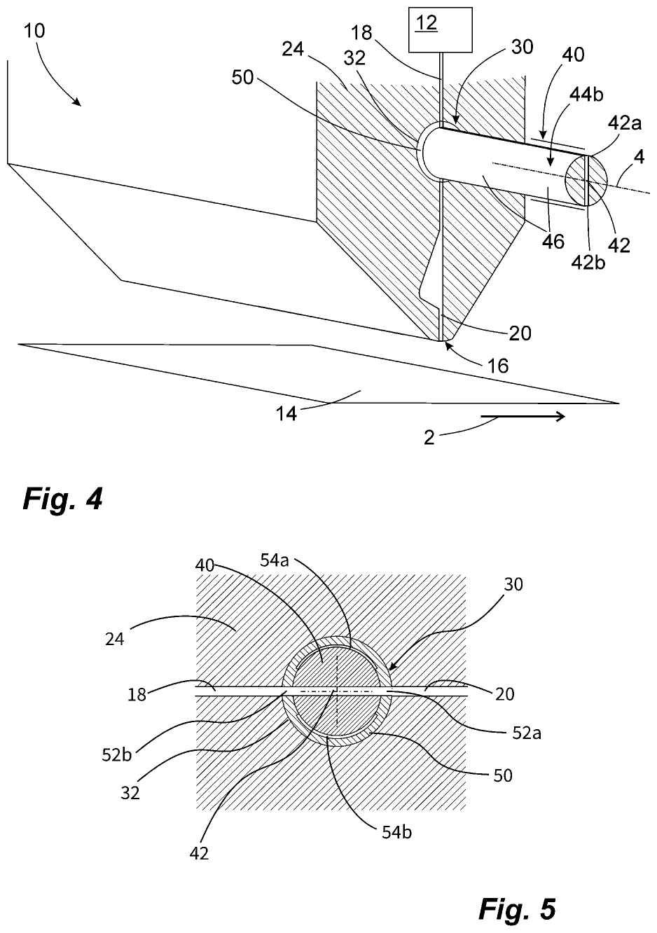

FIG. 4 shows one example of a coating installation 10. This coating installation of applies a coating material from a paste reservoir 12 to a substrate 14 moving continuously in the direction of the arrow 2 during the coating operation. For this purpose, there is provided a slot-shaped nozzle 16 through which the coating material can be applied to the substrate 14 in the form of a wide coating film. Between the paste reservoir 12 and the slotted nozzle 16 there is provided a slotted valve 30 which serves the purpose of allowing and of interrupting, in alternating fashion, the feed of coating material to the slotted nozzle 16.

The slotted valve 30 has a valve bore 32 incorporated into a basic body 24 and in this example is formed as a cylindrical bore. Opening into this bore is a feed duct 18 that feeds pressurized coating material from the paste reservoir 12 to the slotted valve 30. On the opposite side of the valve bore 32, the valve bore 32 connects by a slot-shaped exit to a nozzle duct 20 leading to the slotted nozzle 16.

A valve sleeve 50 such as that illustrated in FIG. 1 is inserted in a rotationally fixed manner into the valve bore extending in the valve direction of extent 4. The valve control rod 40 illustrated in FIG. 2 is inserted into the valve sleeve 50 and rotatable about an axis of rotation 4 oriented in the valve direction of extent 4. The inflow of coating material to the slotted nozzle 16 is permitted or interrupted depending on the rotational position of the valve control rod 40 within the valve bore 32.

FIG. 5 shows a cross section, in the form of a detail, through the slotted valve 30 illustrated in FIG. 4. The slotted valve 30 is in the passage position. In this example, the feed duct 18 and the nozzle duct 20 are communicatively connected via the valve duct 42 and the sleeve inlet 52a and the sleeve outlet 52b.

1. A method of producing a battery electrode, comprising:
dispensing a pasty coating material by a coating installation onto a surface of a moving substrate,
wherein the coating installation comprises:
a switchable slotted valve,
a feed device that feeds the pasty coating material to the slotted valve, and
a slotted nozzle that adjoins the slotted valve and dispenses the pasty coating material onto the surface to be coated therewith;
the switchable slotted valve comprises:
a valve bore incorporated into a valve basic body, oriented in a valve direction of extent and having an inner circumferential surface,
a feed duct arranged in a region of the inner circumferential surface of the valve bore and opens into the valve bore,
a nozzle duct arranged in the region of the inner circumferential surface of the valve bore and leads out from the valve bore,
a valve sleeve arranged in the valve bore and having an inner circumferential surface that delimits a cavity oriented in the valve direction of extent, and an outer circumferential surface, wherein the valve sleeve comprises a slot-shaped sleeve inlet opening into the cavity and a slot-shaped sleeve outlet leading out from the cavity, and
a valve control rod arranged in the valve bore, and is traversed b y a valve duct having a slot-shaped duct inlet and a slot-shaped duct outlet; and
the valve sleeve is non-rotatably mounted in the valve bore such that the feed duct connects to the cavity via the sleeve inlet, and the cavity connects to the nozzle duct via the sleeve outlet,
the valve control rod is mounted in the cavity of the valve sleeve and adapted to be rotatable about an axis of rotation extending in the valve direction of extent, and
the valve control rod is rotatable in the valve sleeve between a passage position and a closed position, wherein, in the passage position, the feed duct and the nozzle duct communicatively connect via the valve duct and the sleeve inlet and the sleeve outlet, and wherein, in a closed position, the nozzle duct is isolated from the feed duct by the valve control rod.

2. The method according to claim 1, wherein:
the valve control rod is cylindrical and comprises an outer circumferential surface breached only by the slot-shaped duct inlet and the slot-shaped duct outlet.

3. The method according to claim 1, wherein:
the valve control rod comprises an outer circumferential surface breached by the slot-shaped duct inlet and the slot-shaped duct outlet,
bearing surfaces that, for bearing the valve control rod, lie against the inner circumferential surface of the valve sleeve, are provided on the valve control rod in the region of two partial surfaces of the outer circumferential surface between the slot-shaped duct inlet and the slot-shaped duct outlet, and
depression regions are provided on the outer circumferential partial surfaces, in the region of which depression regions the respective outer circumferential partial surface does not lie against the inner circumferential surface of the valve sleeve.

4. The method according to claim 1, wherein:
the valve control rod comprises an outer circumferential surface breached only by the slot-shaped duct inlet and the slot-shaped duct outlet,
the outer circumferential surface of the valve control rod lies in certain regions directly against the inner circumferential surface of the valve sleeve, and
the inner circumferential surface of the valve sleeve comprises at least one depressed subregion in which the outer circumferential surface of the valve control rod does not lie against the inner circumferential surface of the valve sleeve.
